(19) United States
(12) Patent Application Publication
(10) Pub. No.: US 2009/0138457 A1
(43) Pub. Date: May 28, 2009

(54) GROUPING AND WEIGHTING MEDIA CATEGORIES WITH TIME PERIODS

(75) Inventor: Waymen J. Askey, Cary, NC (US)

Correspondence Address: WITHROW & TERRANOVA CT, 100 REGENCY FOREST DRIVE , SUITE 160, CARY, NC, 27518, US

(73) Assignee: CONCERT TECHNOLOGY CORPORATION, Durham, NC (US)

(21) Appl. No.: 11/944,949

(22) Filed: Nov. 26, 2007

(51) Int. Cl. G06F 7/00

(52) U.S. Cl. 707/5

(57) ABSTRACT

A method and system for scoring media items are provided. In general, a number of media categories are defined. Each of the media categories is defined by at least one criterion such as at least one genre, at least one artist, or the like, or any combination thereof. For each of the media categories, weights are assigned to a number of time periods. Thus, a weight assigned to a particular time period, such as a decade, may vary between media categories. In one embodiment, the criteria defining the media categories and the weights assigned to the time periods within each of the media categories are user-defined. Media items are then matched to the media categories and scored as a function of the weights assigned to the time periods for the matching media categories.

### FIELD OF THE INVENTION

The present invention relates to scoring media items such as songs, videos, and the like.

### BACKGROUND OF THE INVENTION

In today's digital world, the number of digital media items, such as songs and videos, is enormous. For example, Apple's iTunes® Store currently has a catalog of 6 million songs, 100,000 podcasts, 30,000 audiobooks, 600 TV shows, and 500 movies. Of course, not all of these media items are of interest to any one user. As such, there is a need for a method and system for identifying media items of interest to a user. In a similar fashion, personal media collections stored on users' personal computers or portable media players have also become large. Thus, there is also a need for prioritizing media items in a user's personal media collection.

### SUMMARY OF THE INVENTION

The present invention relates to scoring media items. The scores of the media items may be used to prioritize media items in a playlist, make recommendations to a user in an e-commerce system, or the like. In general, a number of media categories are defined. Each of the media categories is defined by at least one criterion such as at least one genre, at least one artist, or the like, or any combination thereof. For each of the media categories, weights are assigned to a number of time periods. Preferably, the time periods are historical time periods. Thus, a weight assigned to a particular time period, such as a decade, may vary between media categories. In one embodiment, the criteria defining the media categories and the weights assigned to the time periods within each of the media categories are user-defined. Media items are then matched to the media categories and scored as a function of the weights assigned to the time periods for the matching media categories.

In one embodiment, media items are scored as a function of the weights assigned to the time periods for each of the media categories. More specifically, when a media item is to be scored, the media item is first matched to at least one of the media categories by comparing metadata describing the media item to the criteria defining the media categories. Then, for each matching media category, a score for the media item is generated as a function of the weight assigned to the time period that includes the date of release of the media item for the matching media category. In one embodiment, if there is more than one matching media category, the highest score from the scores for the matching media categories is selected as the score for the media item.

In another embodiment, media items are scored as a function of the weights assigned to the time periods for each of the media categories as well as weights assigned to the media categories. More specifically, weights may additionally be assigned to the media categories. Preferably, the weights assigned to the media categories are user-defined. When a media item is to be scored, the media item is first matched to at least one of the media categories by comparing metadata describing the media item to the criteria defining the media categories. Then, for each matching media category, a score for the media item is generated as a function of both the weight assigned to the matching media category and the weight assigned to the time period that includes the date of release of the media item for the matching media category. In one embodiment, if there is more than one matching media category, the highest score from the scores for the matching media categories is selected as the score for the media item.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a flow chart illustrating a process for scoring media items based on media categories and weights assigned to time periods for each of those media categories according to one embodiment of the present invention;

FIG. 2 is an exemplary Graphical User Interface (GUI) enabling a user to define the media categories, weights assigned to the media categories, and the weights assigned to the time periods for each of the media categories according to one embodiment of the present invention;

FIGS. 3A and 3B provide a flow chart illustrating a more detailed process for scoring media items based on the media categories and the weights assigned to the time periods for each of those media categories according to one embodiment of the present invention;

FIG. 4 illustrates a first exemplary recommendation system incorporating the scoring process of the present invention;

FIG. 5 illustrates the operation of the recommendation system of FIG. 4 according to one embodiment of the present invention;

FIG. 6 illustrates a second exemplary recommendation system incorporating the scoring process of the present invention;

FIG. 7 illustrates the operation of the recommendation system of FIG. 6 according to one embodiment of the present invention;

FIG. 8 is a flow chart illustrating a process for scoring media items within the recommendation systems of FIGS. 4 through 7 according to one embodiment of the present invention;

FIG. 9 is an exemplary GUI including a listing of media items sorted based on scores generated according to the present invention;

FIG. 10 is a block diagram of one of the peer devices of FIG. 4; and

FIG. 11 is a block diagram of one of the peer devices of FIG. 6.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

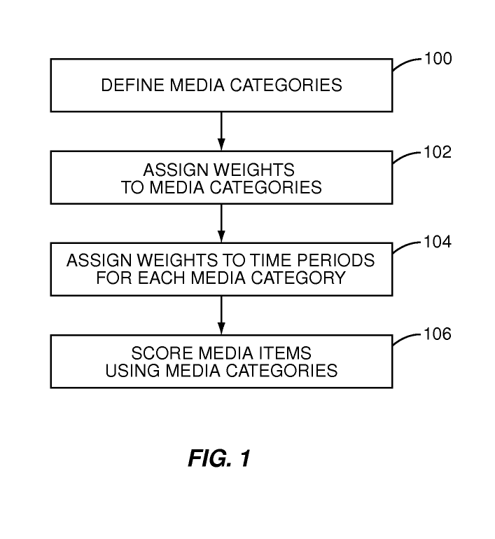

The present invention relates to scoring media items such as songs, videos, or the like. FIG. 1 illustrates a process for scoring media items according to one embodiment of the present invention. First, the media categories are defined (step 100). More specifically, for music, a media category may be defined by criteria such as, for example, at least one genre, at least one artist, or the like. For videos, a media category may be defined by criteria such as, for example, at least one genre, at least one actor/actress or other participants appearing in the videos, or the like. Preferably, the media categories are user-defined.

Optionally, at some point after the media categories are defined or alternatively while the media categories are being defined, weights are assigned to the media categories (step 102). The weights assigned to the media categories are also referred to herein as media category weights. As used herein, weights may generally be any type of relative values. Preferably, the weights are numerical values. However, the weights may alternatively be other types of relative values such as, for example, “high,” “medium,” and “low,” or the like. In one embodiment, the media category weights are user-defined. However, the media category weights may alternatively be programmatically determined based on an analysis of a music collection of an associated user, an analysis of one or more playlists created by the associated user, an analysis of a play history of the associated user, or the like.

It should be noted that the media category weights enable a user to easily adjust weighting of entire groups of criterion rather than a single criterion. For example, if a media category is defined by a number of genres such as “Big Band,” “Blues,” “Jazz,” “Swing,” and “Vocal,” then a weighting applied to all of these genres can be adjusted by controlling a single weight applied to the media category. For more information regarding applying weights to categories, or groups, the interested reader is directed to commonly owned and assigned U.S. patent application Ser. No. 11/759,408, entitled SYSTEM AND METHOD FOR ASSIGNING USER PREFERENCE SETTINGS TO FIELDS IN A CATEGORY, PARTICULARLY A MEDIA CATEGORY, which was filed on Jun. 7, 2007 and is hereby incorporated herein by reference in its entirety.

Next, for each of the media categories, weights are assigned to a number of time periods (step 104). The weights assigned to the time periods are also referred to herein as time period weights. More specifically, for each of the media categories, a number of time periods are defined. The time periods may be, for example, decades. However, the present invention is not limited thereto. The time periods may be of any duration such as, for example, 1 year, 2 years, 3 years, 4 years, 5 years, etc. The time periods may be system-defined or user-defined. Preferably, the time periods are the same for each of the media categories. However, the present invention is not limited thereto. For each media category, weights are assigned to the time periods for that media category. Thus, the weight assigned to a particular time period for a first media category may be different from the weight assigned to that same time period for a second media category. The time period weights may be assigned by an associated user or assigned by the system based on, for example, an analysis of a media collection of the associated user, an analysis of one or more playlists of the associated user, an analysis of a play history of the associated user, or the like. Lastly, media items are scored using the media categories (step 106). More specifically, as discussed below, media items are scored as a function of: (1) the time period weights or (2) both the time period weights and the media category weights. Note that, as used herein, a “score” is preferably a numerical value. However, the present invention is not limited thereto. A “score” may be any indicator of a degree of relevance of a media item. For example, the score may be “highly relevant,” “relevant,” “moderately relevant,” “irrelevant,” “highly relevant.”

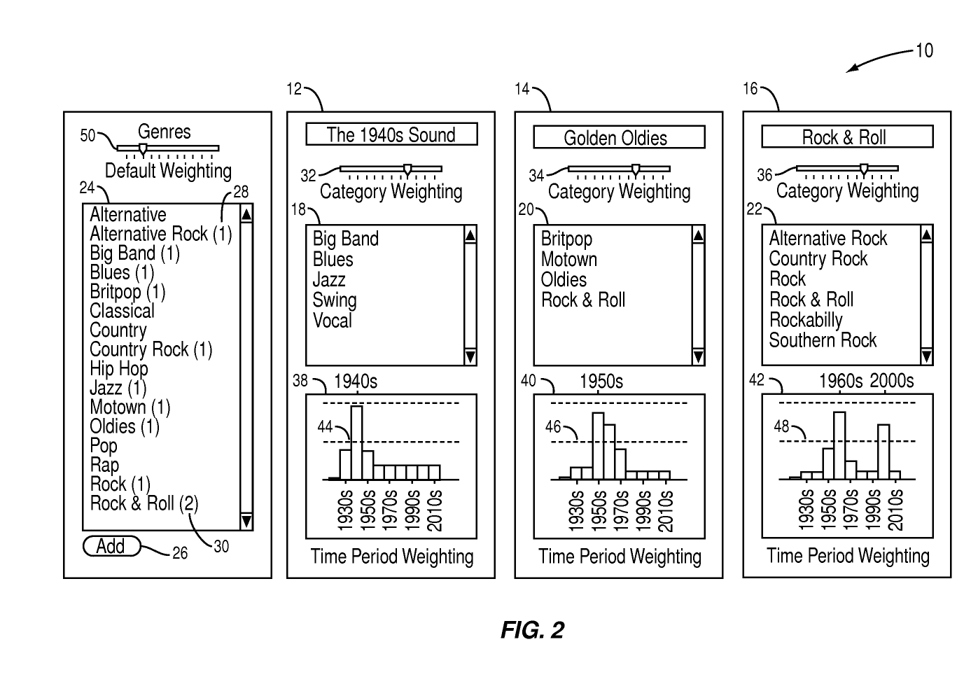

FIG. 2 illustrates an exemplary Graphical User Interface (GUI) 10 for defining the media categories, the media category weights, and the time period weights according to one embodiment of the present invention. Note that while this example deals primarily with media categories for songs, a similar GUI 10 may be utilized for other media types such as videos. Further note that while the GUI 10 of FIG. 2 utilizes genres as the criteria for defining the media categories, the present invention is not limited thereto.

The GUI 10 includes three media categories 12, 14, and 16. The media categories 12, 14, and 16 are entitled “The 1940s Sound,” “Golden Oldies,” and “Rock & Roll,” respectively. The titles of the media categories 12, 14, and 16 are preferably user-defined but may alternatively be system-defined. Note that while there are three media categories 12, 14, and 16 in this example, there may be any number of media categories. The media categories 12, 14, and 16 are defined by criteria listed in criteria windows 18, 20, and 22, respectively. In this example, the criteria are genres selected from a master genre list 24. For example, genres may be added to the criteria for the media categories 12, 14, and 16 by dragging-and-dropping the genres from the master genre list 24 to the desired criteria windows 18, 20, and 22.

The master genre list 24 is a listing of all known genres. As new genres are defined, the new genres may be automatically detected and added to the master genre list 24 or manually added via, in this example, an add button 26. Note that, in this embodiment, the master genre list 24 also includes indicators, such as indicators 28 and 30, that are indicative of the number of media categories for which each of the genres has been selected as a criterion. For example, the indicator 28 indicates that the “Alternative Rock” genre has been selected as a criterion for one media category, which in this example is the media category 16. The indicator 30 indicates that the “Rock & Roll” genre has been selected as a criterion for two media categories, which in this example are the media categories 14 and 16.

The GUI 10 also includes media category weight assignment functions 32, 34, and 36 and time period weight assignment functions 38, 40, and 42 for the media categories 12, 14, and 16, respectively. In this example, the media category weight assignment functions 32, 34, and 36 are sliding bars that enable a user to assign weights to the media categories 12, 14, and 16. However, the present invention is not limited thereto. Further, initially the media category weights may be set to some default value. Alternatively, initial values for the media category weights may be determined based on an analysis of the music collection of an associated user, an analysis of one or more playlists of the associated user, an analysis of a play history for the associated user, or the like. The user may thereafter adjust the media category weights via the media category weight assignment functions 32, 34, and 36.

The time period weight assignment functions 38, 40, and 42 generally enable a user to assign weights to each of a number of time periods for the media categories 12, 14, and 16, respectively. In this example, the time periods are decades, and the time period weight assignment functions 38, 40, and 42 include bar graphs 44, 46, and 48, respectively. However, the present invention is not limited thereto. Using the bar graph 44 of the media category weight assignment function 38 as an example, the user may assign or adjust the weights assigned to each of the decades by adjusting the associated bar in the bar graph 44. Thus, for example, the user may adjust the weight assigned to the 1940s by adjusting the height of the associated bar in the bar graph 44. In one embodiment, the user may assign weights to the time periods by moving a mouse pointer over the bar graph 44 while holding a primary mouse button down. As the mouse pointer moves horizontally across the bar graph 44, the weight for each of the time periods is adjusted to the level indicated by the relative position of the mouse pointer within the bar graph 44. Thus, a single mouse down followed by a drag across the entire bar graph 44 can be used to set the weights of all of the time periods. At the top of the bar graph 44, there may be indicators or labels identifying the time periods that have the highest weights. In a similar fashion, the time period weight assignment functions 40 and 42 enable the user to assign or adjust the weights of the time periods for the media categories 14 and 16, respectively.

Initially, the time period weights may be set to some default value. Alternatively, initial values for the time period weights may be determined based on an analysis of the music collection of an associated user, an analysis of one or more playlists of the associated user, an analysis of a play history for the associated user, or the like. The user may thereafter adjust the time period weights via the time period weight assignment functions 38, 40, and 42.

Note that the time periods for each of the media categories 12, 14, and 16 are preferably the same time periods. However, the present invention is not limited thereto. The media categories 12, 14, and 16 may alternatively have different time periods. For example, while the media category 12 includes the decades from the 1930s through the 2000s, the media category 14 may alternatively include only the decades from the 1950s through the 1980s. This effect may of course also be obtained by adjusting the weights of the 1930s, 1940s, 1990s, and 2000s to a minimum value. As another example, while the time periods of the media category 12 are decades, the time periods of the other media categories 14 and 16 may have some other duration such as 1 year, 2 years, 3 years, 4 years, 5 years, etc. Also note that the duration of the time periods may also vary within a single media category.

The GUI 10 also includes a default weight assignment function 50 that enables the user to set a default weight for media items that do not satisfy the criteria of any of the media categories 12, 14, and 16. In this example, the default weight assignment function 50 is a sliding bar. However, the present invention is not limited thereto.

It should be noted that a smoothing feature or process may optionally be utilized to smooth abrupt changes in time period weights between adjacent time periods. For example, if the 1940s time period for the media category 12 has a weight of 10 and the 1950s time period for the media category 12 has a weight of 4, an adjusted time period weight may be provided for a transition period such as, for example, 1949 through 1951. Thus, for example, the adjusted time period weight for the transition period may be computed as: weight₁₉₄₀−(weight₁₉₄₀−weight₁₉₅₀ₛ)/2, which for this example is 7. It should be appreciated that other similar or more complex smoothing techniques may be used.

More specifically, in one embodiment, the smoothing process may be performed by obtaining original weights for the time periods for each of the media categories 12, 14, and 16 from the user. A smoothing process may then be performed to adjust the weights during transition periods between adjacent time periods. Thus, using the example above, the smoothing process may define a transition time period of 1949 through 1951 and assign it a weight of 7. Likewise, a transition time period of 1939 through 1941 may be defined and assigned a weight of 7. As a result, there would be a resultant time period of 1939 through 1941 having a weight of 7, a resultant time period of 1942 through 1948 having a weight of 10, and a resultant time period of 1949 through 1951 having a weight of 7. Once the smoothing process is completed for all of the time periods for each of the media categories 12, 14, and 16, the resultant set of time periods and weights for those time periods are used for the scoring process.

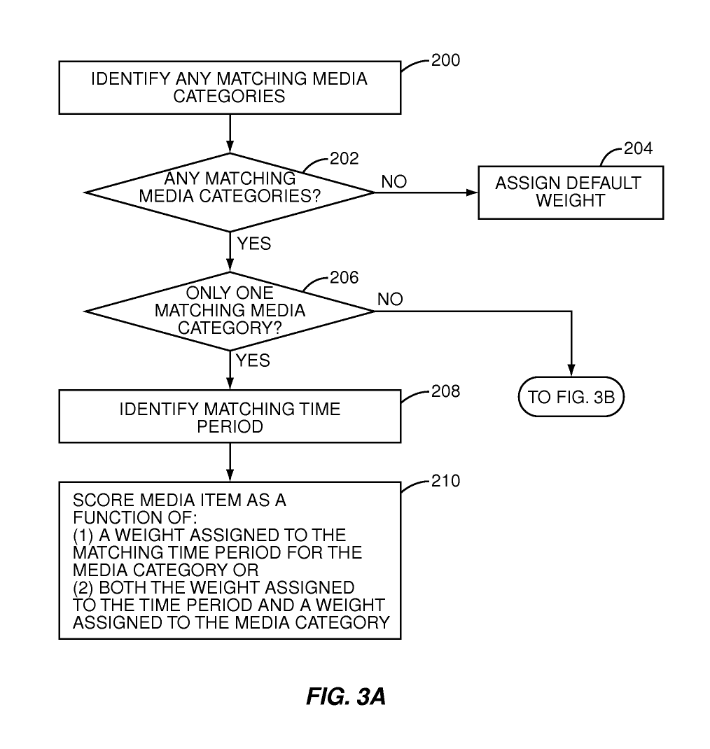

FIGS. 3A and 3B illustrate a process for scoring media items based on media categories and time period weights for the media categories according to one embodiment of the present invention. Note that the following discussion uses the media categories 12, 14, and 16 of FIG. 2 as an example. However, it should be appreciated that the following discussion is equally applicable to media categories having criteria other than genres and media content types other than songs.

First, in order to score a media item, one or more matching media categories are first identified (step 200). More specifically, metadata describing the media item is compared to the criteria defining the media categories 12, 14, and 16. The metadata generally includes information relevant to the criteria defined for the media categories 12, 14, and 16. In this example, the metadata for the media item includes the genre of the media item. However, the present invention is not limited thereto. For example, metadata describing a song may include a genre of the song, a title of the song, an artist of the song, an album on which the song was released, a date of release of the song, and the like. The metadata may, for example, be included within the headers of the song file or in a separate metadata file. Thus, if the media item is a song from the “Rock & Roll” genre, the media categories 14 and 16 are identified as matching media categories. If the media item is a song from the “Big Band” genre, the media category 12 is identified as a matching media category. However, if the media item is a song from the “Classical” genre, then there is no matching media category since none of the media categories 12, 14, and 16 include the “Classical” genre as a criterion.

Next, a determination is made as to whether there are any matching media categories (step 202). If not, the media item is assigned or given the default weight, which, as discussed above, may be set by the default weight assignment function 50 (step 204). If there are one or more matching media categories, a decision is then made as to whether there is only one matching media category or more than one matching media category (step 206). If there is only one matching media category, a matching time period from the matching media category is then identified (step 208). More specifically, in the preferred embodiment, the matching time period is identified based on the date of release of the media item. For example, if the media category 12 is the matching media category and the release date for the media item is 1955, then the 1950s decade is identified as the matching time period. While the date of release is used herein, other time stamps such as, for example, a date of creation of the media item may be used.

Once the matching media category and the matching time period within the matching media category are identified, the media item is scored as a function of: (1) the weight assigned to the matching time period within the matching media category or (2) the weight assigned to the matching time period within the matching media category and the weight assigned to the matching media category (step 210). For example, the time period weight and the media category weight may be multiplied, added, or the like in order to provide a score for the media item. This score may then be used as a final score for the media item. Alternatively, the score may be used as part of an additional scoring function to provide a final score for the media item. For example, the score provided in step 210 may be combined with other scores or weights relating to other user preferences in order to provide a final score for the media item.

Returning to step 206, if there are two or more matching media categories, a first matching media category is selected (step 212), and a matching time period for the first matching media category is identified (step 214). Again, the matching time period is preferably identified based on the release date of the media item. However, the present invention is not limited thereto. Once the matching time period is identified, the media item is scored as a function of: (1) the weight assigned to the matching time period within the first matching media category or (2) the weight assigned to the matching time period within the first matching media category and the weight assigned to the first matching media category (step 216). At this point, a next matching media category is selected (step 218), and a matching time period is then identified for the next matching media category (step 220). The media item is then scored as a function of: (1) the weight assigned to the matching time period within the next matching media category or (2) the weight assigned to the matching time period within the next matching media category and the weight assigned to the next matching media category (step 222).

A determination is then made as to whether the last matching media category has been reached (step 224). If not, the process returns to step 218 and is repeated. If the last matching media category has been reached, a highest score from the scores generated for the matching media categories is selected as a score for the media item (step 226). This score may then be used as a final score for the media item. Alternatively, the score may be used as part of an additional scoring function to provide a final score for the media item. For example, the score provided in step 226 may be combined with other scores or weights relating to other user preferences in order to provide a final score for the media item. Note that step 226 is optional. Alternatively, the scores of all of the matching media categories may be used in an additional scoring process to determine a final score for the media item.

It should be noted that the scoring process of FIGS. 3A and 3B is exemplary and not intended to limit the scope of the present invention. One of ordinary skill in the art will recognize various changes to both the arrangement and ordering of the steps of FIGS. 3A and 3B upon reading this specification. For example, step 226 may alternatively be performed in an iterative fashion within the loop of steps 218 through 224.

The scoring process discussed herein may be used for any desired purposes such as, for example, scoring media items in a recommendation system, prioritizing or sorting songs in a playlist, generating a playlist, or the like. Further, the scoring process may be implemented on any type of computing system such as a client/server system or a Peer-to-Peer (P2P) system. For example, the scoring process may be implemented on a server hosting a music distribution service, a user device, or the like. More specifically, a music distribution service such as, for example, Apple's iTunes® Store may score songs, movies, and/or television shows as discussed above and recommend those having a score above some threshold level to the associated user. Similarly, peers in a P2P distribution network may score available media items to identify media items of interest to a user. As another example, a number of songs in a user's music collection may be scored using the scoring process described above. The songs may be scored locally at the user's device or remotely by a central server. Playback of the songs at the user's device may then be prioritized, and optionally automatically effected, based on the scores of the songs. In addition or alternatively, one or more playlists may be generated based on the scores of the songs.

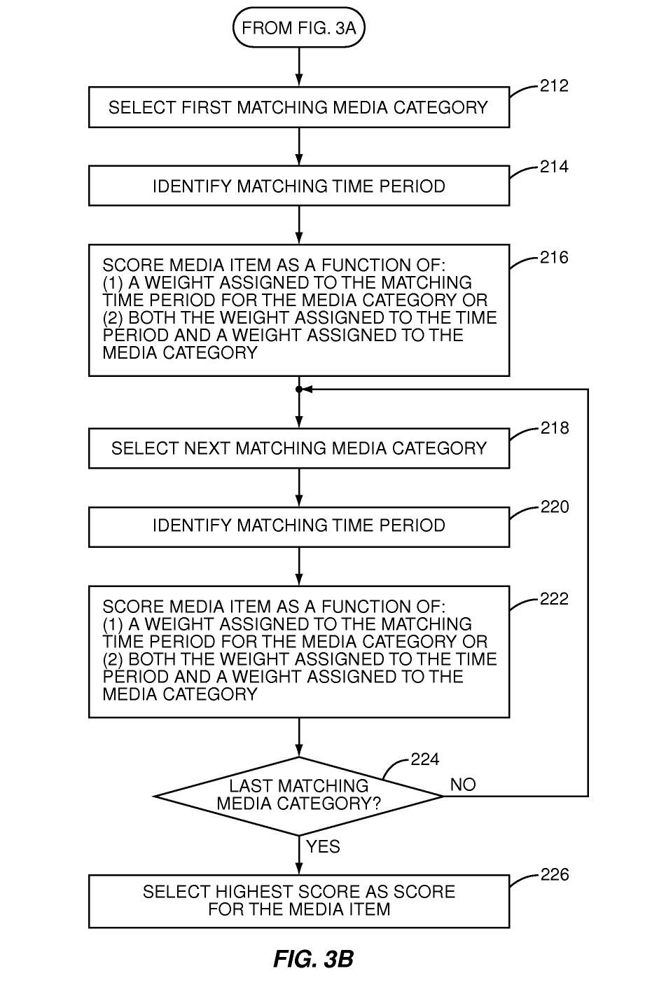

As a final example, the scoring process discussed herein may be used in a social recommendation system such as that disclosed in commonly owned and assigned U.S. patent application Ser. No. 11/484,130, entitled P2P NETWORK FOR PROVIDING REAL TIME MEDIA RECOMMENDATIONS, which was filed on Jul. 11, 2006 and is hereby incorporated herein by reference in its entirety. More specifically, FIG. 4 illustrates a system 52 incorporating a peer-to-peer (P2P) network for providing real time song recommendations wherein the recommendations are scored utilizing the scoring process discussed above according to one embodiment of the present invention. Note that while the following discussion focuses on song recommendations for clarity and ease of discussion, the present invention is equally applicable to other types of recommendations such as videos, as will be apparent to one of ordinary skill in the art upon reading this disclosure. Exemplary videos are movies, television programs, video clips, and the like.

In general, the system 52 includes a number of peer devices 54, 56, and 58 which are optionally connected to a music distribution service 60 via a network 62, which may be, for example, a distributed public network such as, but not limited to, the Internet. The music distribution service 60 may be, for example, a subscription-based music service, a music service enabling purchase of single songs or albums, or the like. For example, the music distribution service 60 may be a subscription-based music service such as or similar to Yahoo! Music Unlimited digital music service and RealNetwork's Rhapsody digital music service. Note that while three peer devices 54, 56, and 58 are illustrated, the system 52 may include any number of two or more peer devices.

In this embodiment, the peer devices 54, 56, and 58 are preferably portable devices such as, but not limited to, portable audio players, mobile telephones, Personal Digital Assistants (PDAs), or the like having audio playback capabilities. However, the peer devices 54, 56, and 58 may alternatively be stationary devices such as a personal computer or the like. The peer devices 54, 56, and 58 include communication interfaces communicatively coupling the peer devices 54, 56, and 58 to form a P2P network. The communication interfaces can be wireless interfaces and may provide wireless communication according to, for example, one of the suite of IEEE 802.11 standards, the Bluetooth standard, or the like.

The peer device 54 includes a music player 64, a recommendation engine 66, and a music collection 68. The music player 64 may be implemented in software, hardware, or a combination of hardware and software. In general, the music player 64 operates to play songs from the music collection 68. The recommendation engine 66 may be implemented in software, hardware, or a combination of hardware and software. The recommendation engine 66 may alternatively be incorporated into the music player 64. The music collection 68 includes any number of song files stored in one or more digital storage units such as, for example, one or more hard-disc drives, one or more memory cards, internal Random-Access Memory (RAM), one or more associated external digital storage devices, or the like.

In operation, each time a song is played by the music player 64, the recommendation engine 66 operates to provide a recommendation identifying the song to the other peer devices 56 and 58 via the P2P network. The recommendation may or may not include the song. In one embodiment, the recommendation may be a recommendation file including information identifying the song such as a Globally Unique Identifier (GUID), the title of the song, or the like. In addition, as discussed below in detail, the recommendation engine 66 operates to programmatically, or automatically, select a next song to be played by the music player 64 based on the recommendations received from the other peer devices 56 and 58 identifying songs recently played by the other peer devices 56 and 58 and user preferences associated with the user of the peer device 54.

Like the peer device 54, the peer device 56 includes a music player 70, a recommendation engine 72, and a music collection 74, and the peer device 58 includes a music player 76, a recommendation engine 78, and a music collection 80.

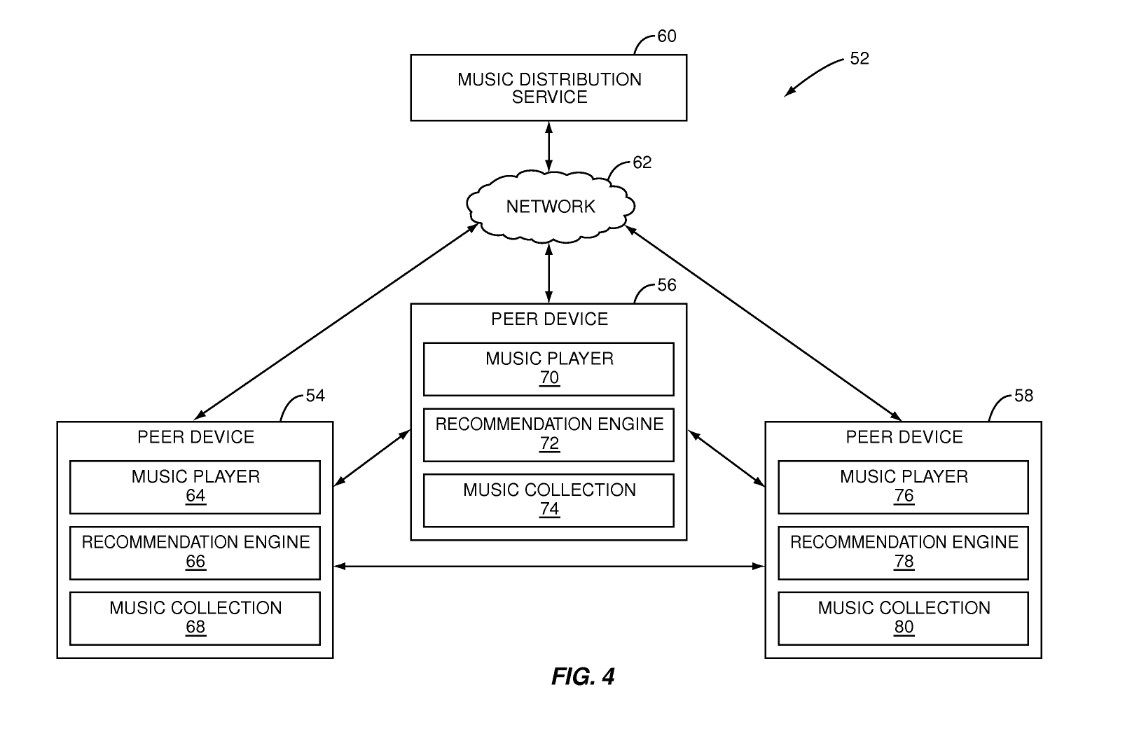

FIG. 5 illustrates the operation of the peer devices 54, 56, and 58 to provide real time song recommendations according to one embodiment of the present invention. In general, the peer devices 56 and 58 play songs and, in response, provide song recommendations to the peer device 54 (steps 300 through 306). More specifically, using the peer device 56 as an example, a song is selected for playback either manually by an associated user or programmatically via an automated process such as the one discussed below. In response to the selection of the song for playback and either prior to, during, or after playback of the song, the recommendation engine 72 of the peer device 56 sends a recommendation identifying the song to the other peer devices 54 and 58. Note that only the recommendation sent to the peer device 54 is illustrated for clarity and ease of discussion. The recommendation may include, but is not limited to: information identifying the song such as a GUID for the song, title of the song, or the like; a Uniform Resource Locator (URL) enabling other peer devices to obtain the song such as a URL enabling download or streaming of the song from the music distribution service 60 or a URL enabling purchase and download of the song from an e-commerce service; a URL enabling download or streaming of a preview of the song from the music distribution service 60 or a similar e-commerce service; metadata describing the song such as ID3 tags including, for example, genre, the title of the song, the artist of the song, the album on which the song can be found, the date of release of the song or album, the lyrics, and the like. The recommendation may also include a list of recommenders including information identifying each user having previously recommended the song and a timestamp for each recommendation.

The peer device 54, and more specifically the recommendation engine 66, may optionally filter the recommendations from the peer devices 56 and 58 (step 308). The recommendation engine 66 of the peer device 54 then automatically selects the next song to play from the songs identified by the recommendations, optionally songs identified by prior recommendations from the peer devices 56 and 58, and optionally locally stored songs from the music collection 68 based on user preferences of the user of the peer device 54 (step 310). As discussed below, the user preferences used to select the next song to play may include the media categories, media category weights, and time period weights for the media categories. Thus, the songs identified by the recommendations, optionally songs identified by prior recommendations, and optionally the songs in the music collection 68 are scored in the manner discussed above with respect to FIGS. 3A and 3B. The songs may be further scored based on additional user preferences such as recommender preferences and availability preferences. The next song to play is then selected based on the scores generated for the songs.

The peer device 54 then obtains and plays the selected song (steps 312 and 314). If the selected song is part of the music collection 68, the recommendation engine 66 obtains the selected song from the music collection 68. If the selected song is not part of the music collection 68, the recommendation engine 66 obtains the selected song from the music distribution service 60 or, alternatively, one of the other peer devices 56 and 58. The recommendation for the song may include a URL providing a link to a source from which the song may be obtained, which may be the music distribution service 60. Note that the score for the selected song may be used to determine whether to automatically download the song from the music distribution service 60 or, alternatively, one of the other peer devices 56 and 58. For example, the recommendation engine 66 may automatically download the selected song if the score for the song is greater than a threshold value. Once obtained, the selected song is played (step 314). In response to selection of the song for playback and either prior to, during, or after playback of the selected song, the recommendation engine 66 of the peer device 54 provides a recommendation identifying the selected song to the other peer devices 56 and 58 (steps 316 and 318).

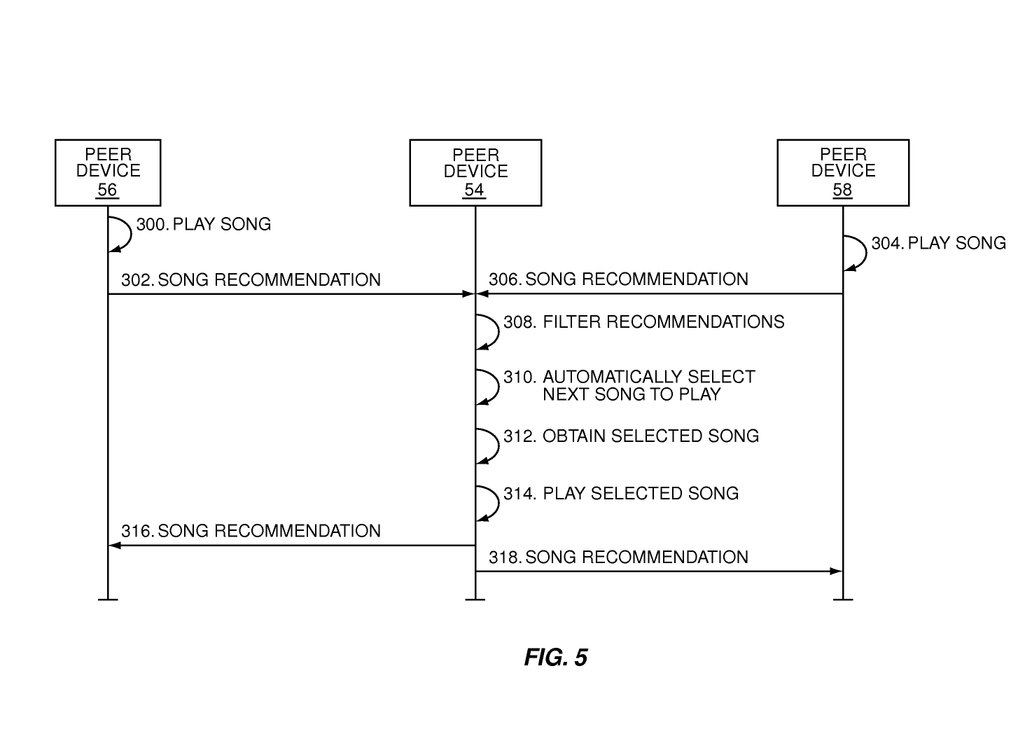

FIG. 6 illustrates a system 52′ according to a second embodiment of the present invention. In this embodiment, the peer devices 54′, 56′, and 58′ form a P2P network via the network 62 and a server 82 operating to direct recommendations between the peer devices 54′, 56′, and 58′. The peer devices 54′, 56′, and 58′ may be any device having a connection to the network 62 and audio playback capabilities. For example, the peer devices 54′, 56′, and 58′ may be personal computers, laptop computers, mobile telephones, portable audio players, PDAs, or the like having either a wired or wireless connection to the network 62. As discussed above with respect to the peer device 54, the peer device 54′ includes a music player 64′, a recommendation engine 66′, and a music collection 68′. Likewise, the peer device 56′ includes a music player 70′, a recommendation engine 72′, and a music collection 74′, and the peer device 58′ includes a music player 76′, a recommendation engine 78′, and a music collection 80′.

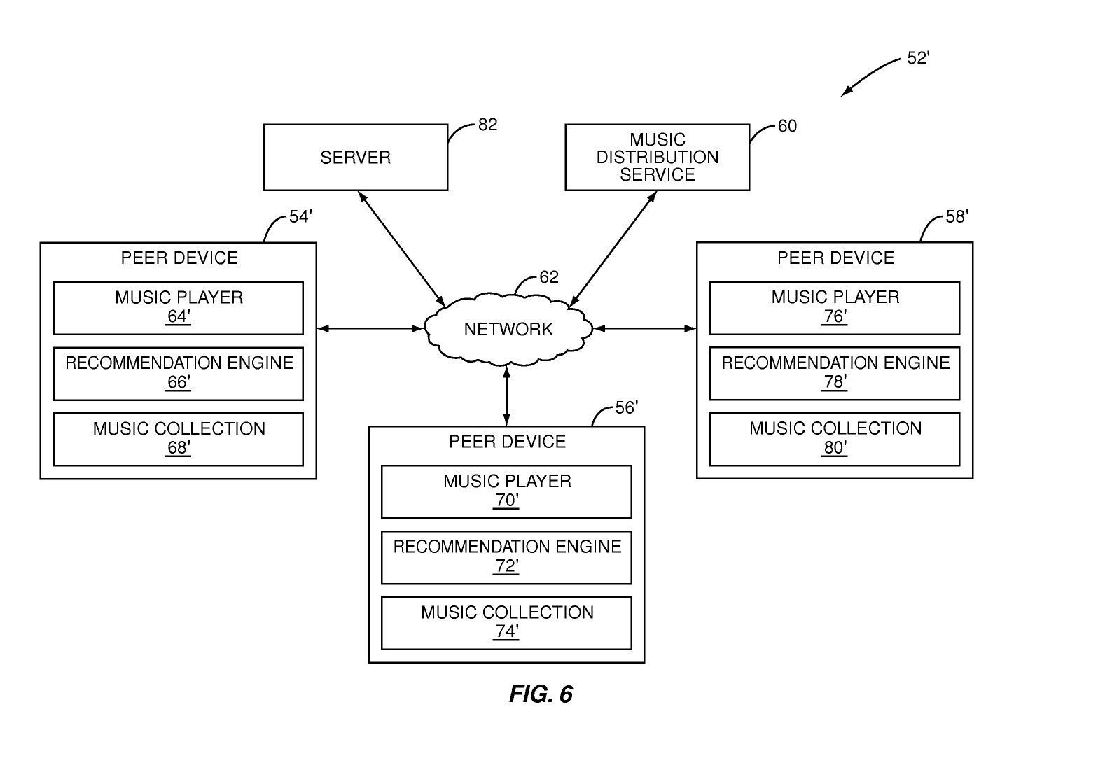

FIG. 7 illustrates the operation of the system 52′ of FIG. 6. Prior to beginning the process, the peer devices 54′, 56′, and 58′ form a P2P network. Since the number of peer devices 54′, 56′, and 58′ that may be connected to the network 62 may be very large, the peer devices 54′, 56′, and 58′ may implement some technique for identifying a desired group of peer devices for the P2P network. For example, the P2P network may be initiated using, for example, an electronic or verbal invitation. As another example, the peer device 54′ may maintain a “buddy list” identifying friends of the user of the peer device 54′, where the peer device 54′ may automatically establish a P2P network with the peer devices of the users identified by the “buddy list” when the peer devices are connected to the network 62. Alternatively, the participants for the P2P network may be identified based on similarities in user profiles.

In this example, once the P2P network is established, the peer device 56′ plays a song and, in response, provides a song recommendation identifying the song to the server 82 (steps 400 and 402). The server 82 then provides the song recommendation to the peer device 54′ (step 404). While not illustrated for clarity, the recommendation for the song may also be sent from the server 82 to the peer device 58′. Note that the peer device 56′ may provide the recommendation to the peer devices 54′ and 58′ separately. Alternatively, the peer device 56′ may provide a single recommendation to the server 82, where the server 82 then provides the recommendation to each of the peer devices 54′ and 58′. The peer device 58′ also plays a song and sends a song recommendation to the peer device 54′ via the server 82 (steps 406 through 410). Again, while not illustrated for clarity, the recommendation from the peer device 58′ is also sent to the peer device 56′.

From this point, the process continues as discussed above. More specifically, the recommendation engine 66′ may optionally filter the recommendations from the other peer devices 56′ and 58′ based on, for example, user, genre, artist, title, album, lyrics, date of release, or the like (step 412). The recommendation engine 66′ then automatically selects a next song to play from the songs identified by the recommendations received from the other peer devices 56′ and 58′, optionally songs identified by previously received recommendations from the peer devices 56′ and 58′, and optionally one or more songs from the music collection 68′ based on user preferences (step 414). In the preferred embodiment discussed below, the songs identified by the current and optionally previous recommendations from the other peer devices 56′ and 58′ and optionally the songs from the music collection 68′ are scored based on the user preferences. Then, based on the scores, the recommendation engine 66′ selects the next song to play.

Once the next song to play is selected, the peer device 54′, and more specifically the recommendation engine 66′, obtains the selected song (step 416). If the selected song is part of the music collection 68′, the song is obtained from the music collection 68′. If the selected song is not part of the music collection 68′, the recommendation engine 66′ obtains the selected song from the music distribution service 60 or, alternatively, one of the other peer devices 56′ and 58′. For example, the selected song may be obtained from a source identified in the recommendation for the song. Once obtained, the selected song is played and a recommendation for the song is provided to the other peer devices 56′ and 58′ via the server 82 (steps 418 through 426).

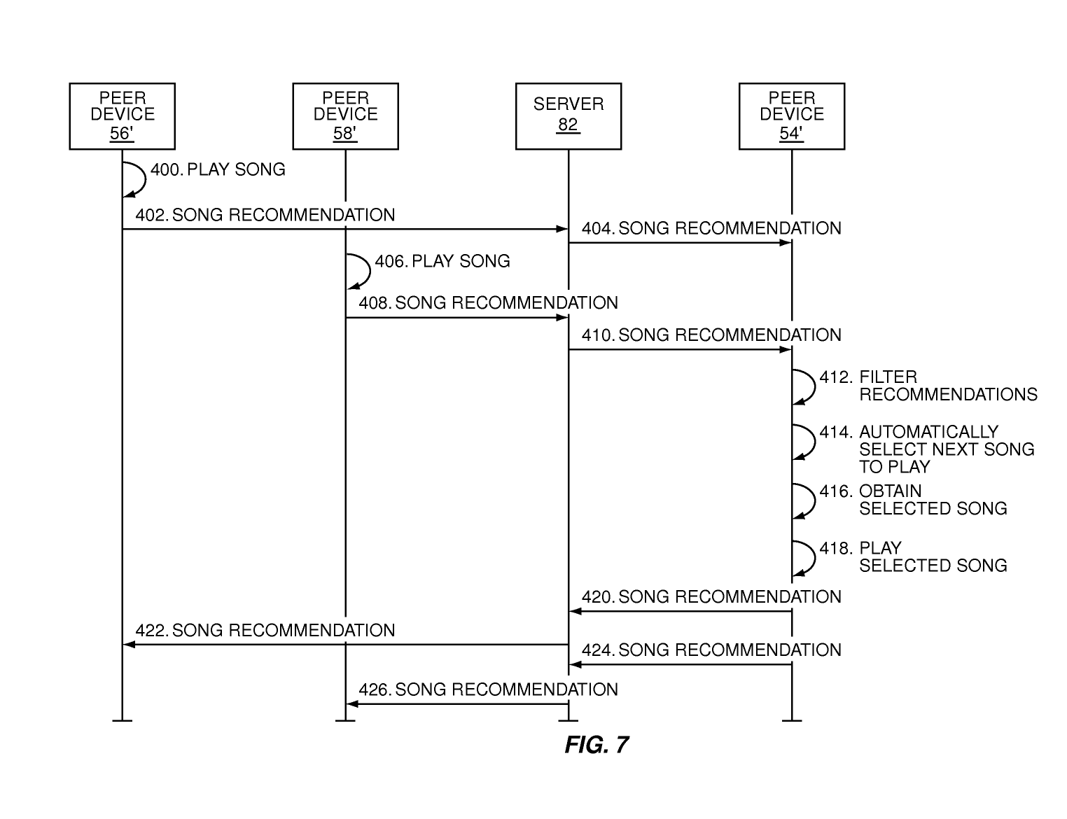

FIG. 8 illustrates the process of automatically selecting a song to play from the songs identified by the recommendations and locally stored songs at the peer device 54′ according to one embodiment of the present invention. However, the following discussion is equally applicable to the other peer devices 56′ and 58′ of FIG. 6, as well as the peer devices 54, 56, and 58 of FIG. 4. First, the user preferences for the user of the peer device 54′ are obtained (step 500). More specifically, the media categories, optionally weights for the media categories, and weights for time periods for each of the media categories are obtained. In one embodiment, the media categories, media category weights, and time period weights are obtained from an associated user via, for example, the GUI 10 of FIG. 2. The user preferences may include additional preferences such as, for example, recommender preferences and availability preferences. The recommender preferences may, for example, assign weights to the users, or recommenders, associated with the other peer devices 56′ and 58′. The availability preferences define weights for different availability states such as, for example, available from the local music collection 68′, available from the music distribution service 60, available from another peer device 56′ and 58′, unavailable, or the like. The user preferences may alternatively be suggested by the recommendation engine 66′ or the server 82 based on, for example, a play history of the peer device 54′. Note that the server 82 may ascertain the play history of the peer device 54′ by monitoring the recommendations from the peer device 54′. The user preferences may be stored locally at the peer device 54′ or obtained from a central server, such as the server 82, via the network 62.

Once recommendations are received from the other peer devices 56′ and 58′, the recommendation engine 66′ scores the songs identified by the recommendations based on the user preferences (step 502). The recommendation engine 66′ also scores one or more local songs from the music collection 68′ (step 504). More specifically, the recommendation engine 66′ scores the recommended songs, optionally including previously recommended songs, and the local songs using the scoring process of FIGS. 3A and 3B. The scores output by the process of FIGS. 3A and 3B may be the final scores for the songs or used in a further scoring process to generate final scores of the songs. The recommendation engine 66′ then selects the next song to play based, at least in part, on the scores of the recommended and local songs (step 506).

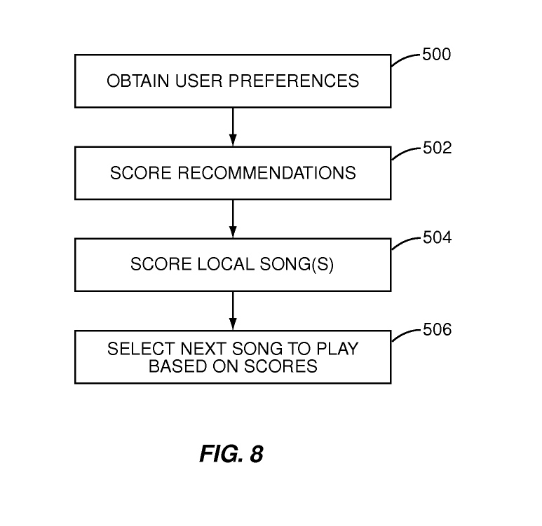

FIG. 9 is an exemplary GUI 84 showing a playlist for the peer device 54′ including both local and recommended songs. However, note that a similar list may be maintained internally by the peer device 54 of FIG. 4 and potentially optimized to display at least a portion of the GUI 84 on the display of the peer device 54. In this example, both the local and recommended songs are scored, as described above, and sorted according to their scores. In addition, while not illustrated, the songs may be sorted based on another criterion, such as media category and score. More specifically, the songs may be sorted first based on genre and then the songs for each genre are further sorted based on score.

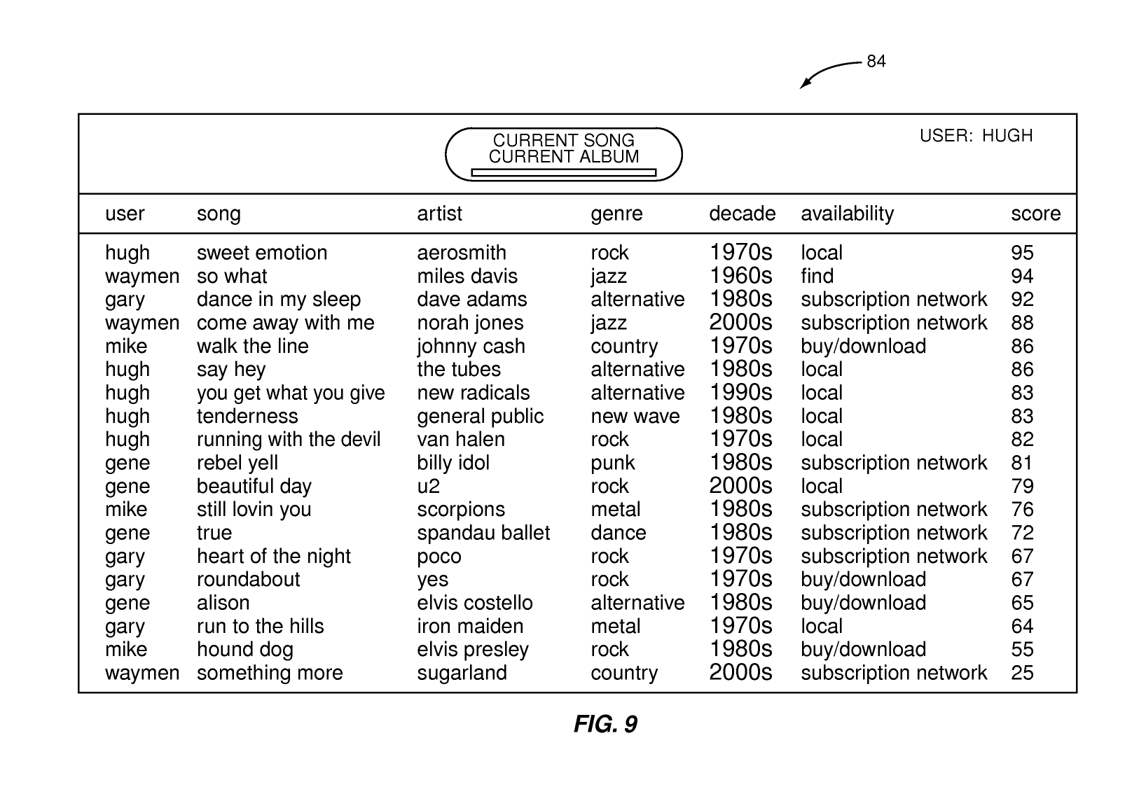

FIG. 10 is a block diagram of an exemplary embodiment of the peer device 54 of FIG. 4. However, the following discussion is equally applicable to the other peer devices 56 and 58. In general, the peer device 54 includes a control system 86 having associated memory 88. In this example, the music player 64 and the recommendation engine 66 are at least partially implemented in software and stored in the memory 88. The peer device 54 also includes a storage unit 90 operating to store the music collection 68. The storage unit 90 may be any number of digital storage devices such as, for example, one or more hard-disc drives, one or more memory cards, RAM, one or more external digital storage devices, or the like. The music collection 68 may alternatively be stored in the memory 88. The peer device 54 also includes a communication interface 92. The communication interface 92 includes a communication interface for establishing the P2P network with the other peer devices 56 and 58. The interface can be a wireless interface and may operate according to, for example, one of the suite of IEEE 802.11 standards, the Bluetooth standard, or the like. The communication interface 92 may also include a network interface communicatively coupling the peer device 54 to the network 62 (FIG. 4). The peer device 54 also includes a user interface 94, which may include components such as a display, speakers, a user input device, and the like.

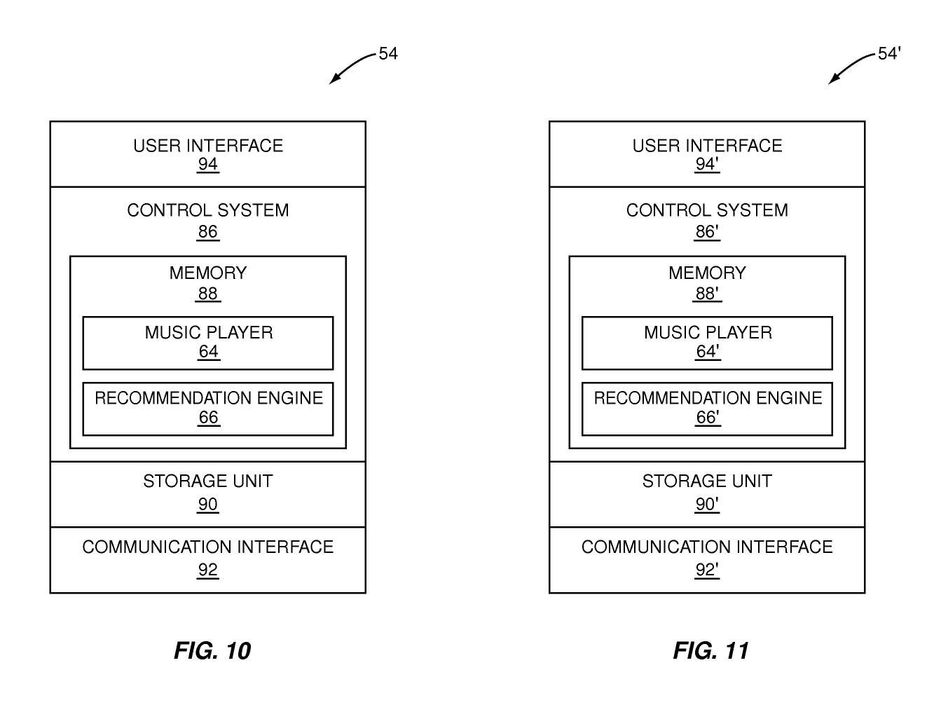

FIG. 11 is a block diagram of an exemplary embodiment of the peer device 54′ of FIG. 6. However, the following discussion is equally applicable to the other peer devices 56′ and 58′. In general, the peer device 54′ includes a control system 86′ having associated memory 88′. In this example, the music player 64′ and the recommendation engine 66′ are at least partially implemented in software and stored in the memory 88′. The peer device 54′ also includes a storage unit 90′ operating to store the music collection 68′. The storage unit 90′ may be any number of digital storage devices such as, for example, one or more hard-disc drives, one or more memory cards, RAM, one or more external digital storage devices, or the like. The music collection 68′ may alternatively be stored in the memory 88′. The peer device 54′ also includes a communication interface 92′. The communication interface 92′ includes a network interface communicatively coupling the peer device 54′ to the network 62. The peer device 54′ also includes a user interface 94′, which may include components such as a display, speakers, a user input device, and the like.

Those skilled in the art will recognize improvements and modifications to the preferred embodiments of the present invention. All such improvements and modifications are considered within the scope of the concepts disclosed herein and the claims that follow.

What is claimed is:

1. A method of scoring a media item comprising:
for each media category in a plurality of media categories, assigning a time period weight to each time period in a plurality of time periods;
identifying a matching media category for the media item from the plurality of media categories;
identifying a matching time period for the media item from the plurality of time periods associated with the matching media category; and
assigning a score to the media item as a function of the time period weight assigned to the matching time period for the matching media category.

2. The method of claim 1 wherein the time period weights assigned to the plurality of time periods for each media category in the plurality of media categories are independent from the time period weights assigned to the plurality of time periods for each other media category in the plurality of media categories.

3. The method of claim 1 wherein a category weight is assigned to each of the plurality of media categories, and scoring the media item comprises scoring the media item as a function of the category weight assigned to the matching media category and the time period weight assigned to the matching time period for the matching media category.

4. The method of claim 1 wherein for each media category in the plurality of media categories, assigning the time period weight to each time period in the plurality of time periods comprises enabling an associated user to assign the time period weight to each time period in the plurality of time periods.

5. The method of claim 1 wherein for each media category in the plurality of media categories, assigning the time period weight to each time period in the plurality of time periods comprises programmatically assigning the time period weight to each time period in the plurality of time periods.

6. The method of claim 5 wherein programmatically assigning the time period weight to each time period in the plurality of time periods comprises programmatically assigning the time period weight assigned to each time period in the plurality of time periods based on an analysis of at least one of a group consisting of: a media collection of an associated user, at least one playlist of the associated user, and a play history of the associated user.

7. The method of claim 1 wherein if there are a plurality of matching media categories, the method further comprises:
identifying the plurality of matching media categories for the media item from the plurality of media categories; and
for each one of the plurality of matching media categories,
identifying a matching time period for the media item from the plurality of time periods for the one of the plurality of matching media categories; and
assigning a score to the media item for the one of the plurality of matching media categories as a function of the time period weight assigned to the matching time period for the one of the plurality of matching media categories.

8. The method of claim 7 further comprising selecting a highest score from the scores for the plurality of matching media categories as a score for the media item.

9. The method of claim 1 further comprising repeating the steps of identifying a matching media category, identifying a matching time period, and assigning a score to the media item for each of a plurality of media items.

10. The method of claim 1 wherein identifying the matching media category for the media item comprises comparing metadata associated with the media item and at least one criterion defining the matching media category.

11. The method of claim 10 wherein each media category in the plurality of media categories including the matching media category is defined by at least one criterion selected from a group consisting of: music genre, music artist, video genre, and video participant.

12. The method of claim 10 wherein the metadata associated with the media item comprises at least one data item selected from a group consisting of: a music genre for the media item if the media item is a song, a music artist of the media item if the media item is a song, a video genre of the media item if the media item is a video, and a video participant appearing in the media item if the media item is a video.

13. The method of claim 1 wherein the plurality of time periods for each one of the plurality of media categories is the same as the plurality of time periods for each other of the plurality of media categories.

14. The method of claim 1 wherein identifying the matching time period for the media item comprises identifying the matching time period for the media item from the plurality of time periods for the matching media category based on one of a group consisting of: a release date of the media item and a date of creation of the media item.

15. The method of claim 1 wherein the score of the media item is used in a recommendation system.

16. The method of claim 1 further comprising:
determining whether to recommend the media item to a user based on the score; and
recommending the media item to the user if a determination is made to recommend the media item to the user.

17. The method of claim 1 wherein the media item is a media item identified by a recommendation received in a peer-to-peer (P2P) social recommendation system, and the method further comprises determining whether to obtain the media item from a remote media content distribution service based on the score.

18. The method of claim 1 wherein the media item is a media item identified by a recommendation received in a peer-to-peer (P2P) social recommendation system, and the method further comprises prioritizing the media item in a playlist based on the score.

19. The method of claim 1 further comprising:
repeating the steps of identifying a matching media category, identifying a matching time period, and assigning a score to the media item for each of a plurality of media items; and
prioritizing playback of the plurality of media items based on the scores assigned to the plurality of media items.

20. The method of claim 1 further comprising assigning a score to the media item based on a default weight if a matching media category from the plurality of media categories is unable to be identified.

21. The method of claim 1 further comprising, for each media category in the plurality of media categories:
obtaining original weights for a plurality of original time periods for the media category; and
applying a smoothing function to the original weights for the plurality of original time periods for the media category to provide the plurality of time periods for the media category and the time period weights assigned to the plurality of time periods for the media category.

22. A system comprising:
a control system adapted to:
for each media category in a plurality of media categories, assign a time period weight to each time period in a plurality of time periods;
identify a matching media category for a media item from the plurality of media categories;
identify a matching time period for the media item from the plurality of time periods for the matching media category; and
assign a score to the media item as a function of the time period weight assigned to the matching time period for the matching media category.

23. The system of claim 22 wherein the time period weights assigned to the plurality of time periods for each media category in the plurality of media categories are independent from the time period weights assigned to the plurality of time periods for each other media category in the plurality of media categories.

24. The system of claim 22 wherein a category weight is assigned to each of the plurality of media categories, and the control system is adapted to score the media item as a function of the category weight assigned to the matching media category and the time period weight assigned to the matching time period for the matching media category.

25. A computer-readable medium, comprising instructions for instructing a computer to:
for each media category in a plurality of media categories, assigning a time period weight to each time period in a plurality of time periods;
identify a matching media category for a media item from the plurality of media categories;
identify a matching time period for the media item from the plurality of time periods for the matching media category; and
assign a score to the media item as a function of the time period weight assigned to the matching time period for the matching media category.
